(19) United States
(12) Patent Application Publication
(10) Pub. No.: US 2010/0216990 A1
(43) Pub. Date: Aug. 26, 2010

(54) NOVEL PHOTOCHROMIC MATERIALS

(75) Inventors: Stephane Jobic, Bouguenais (FR); Martine Bujoli-Doeuff, Suce Sur Erdre (FR); Violaine Coue, Fondettes (FR); Remi Dessapt, Nantes (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Centre National De La Recherche Scient, Paris (FR)

(21) Appl. No.: 12/669,709

(22) PCT Filed: Jul. 16, 2008
(86) PCT No.: PCT/FR08/01041

§ 371 Date: May 5, 2010

(30) Foreign Application Priority Data
Jul. 17, 2007 (FR) 0705149

(51) Int. Cl. C07F 11/00

(52) U.S. Cl. 544/225

(57) ABSTRACT

The invention relates to hybrid organic-inorganic materials containing molybdenum and having photochromic properties. The invention also relates to the use thereof, particularly in cosmetics and in the glass industry, e.g. in glazing applications or in the production of ocular glasses.

One subject of the invention is novel molybdenum-based organic/inorganic hybrid materials having photochromic properties. Another subject of the invention is their use, especially in cosmetics and in the glass field, such as for example in glazing or for the manufacture of spectacle lenses.

Photochromic materials of purely organic or purely inorganic nature have been known for a long time. More recently, a new family of photochromic materials has been the subject of many studies, namely organic/inorganic hybrid materials. The reader may for example refer to the following: T. Yamase, Chem. Rev. (1998) 307-325; V. Coué et al., J. Solid State Chemistry, 179 (2006) 3615-3627; V. Coué et al., Inorganic Chemistry, 46 (2007) 2824-2835

Among the known organic/inorganic hybrid materials there are several based on molybdenum. However, it has been found that the presence of polymolybdenum oxide chains associated with organic ligands, such as H₂DABCO²⁺, is in no way sufficient for obtaining photochromic compounds (M. Evain et al., Acta Cryst. (2006), B62, 790-797). In fact, it has been found that the photochromism and the reversibility of this phenomenon depend on the interaction between the organic part and the inorganic part of the material, without rules enabling these properties to be predicted having been demonstrated (T. Yamase, Chem. Rev. 98 (1998) 307-325).

Furthermore, it has been found that the characteristics of the photochromism phenomenon (rate of color change, excitation energy, stability of the photo-induced state, bleaching rate) vary extremely from one material to another.

The Applicant has now discovered a novel material derived from molybdenum that has photochromic properties superior to those described in the case of the materials of the prior art.

This novel material satisfies formula (I) below:

(H₂DABCO²⁺)₂(R₁R₂NH₂⁺)_{(2-x-y)}(X)ₓ(H₃O⁺)_{y}(Mo₈O₂₇).z(H₂O) (I)

in which:
R₁,R₂, which are identical or different, each represent a C₁-C₁₂ alkyl, C₁-C₁₂ alkenyl or C₁-C₁₂ alkynyl group, which may be linear, branched or cyclic, it being possible for R₁ and R₂ to optionally form together a single alkyl, alkenyl or alkynyl chain so as to form a cyclic structure with the nitrogen atom;
X represents an alcali metal atom chosen, in particular, from: Li, Na, K, Rb, Cs;
x is a real number, where 0≦x≦2;
y is a real number, where 0≦y<2;
z is a real number where 0≦z≦10; and
DABCO represents, as is known, the molecule 1,4-diazabicyclo[2.2.2]octane.

Advantageously, R₁=R₂ in formula (I).

Advantageously, R₁ and R₂ are chosen from C₁-C₁₀ alkyls, better still C₁-C₆ alkyls, in formula (I).

Even more preferably, R₁ and R₂ are chosen from C₁-C₃ alkyls, such as methyl, ethyl, n-propyl, isopropyl, and even more preferably, R₁=R₂=CH₃ in formula (I).

Preferably, 0.5≦x≦1, even more preferably x=0.8.

Preferably, 0.5≦y≦1, even more preferably y=0.7.

Z represents the degree of hydration of the molecule and advantageously 0≦z≦6.

Preferably, X represents an atom chosen from Na and K, advantageously X=Na.

Preferably, the material of the invention satisfies the formula (Ia) below:

(H₂DABCO²⁺)₂((CH₃)₂NH₂⁺)_{0.5}(Na)_{0.8}(H₃O⁺)_{0.7}(Mo₈O₂₇).3(H₂O) (Ia)

Compared with the photochromic materials of the prior art, and in particular in relation to other materials derived from Mo₈O₂₇, the materials of the invention have many advantages: higher rate of coloration; reversibility of the coloration when the material is no longer subjected to an external stimulus; stability of the material; intensity of the coloration. Furthermore, the materials of the invention have the property of being insoluble in water, which has the consequence that, when they are in the presence of a medium containing water, their photochromic properties are not affected by the water.

The material of the invention may be prepared by the process described below:

The precursor compound X₂MoO₄.nH₂O is dissolved in water with 0.2 to 0.3 equivalents, preferably about 0.25 equivalents, of DABCO and 0.8 to 1.2 equivalents, preferably about one equivalent, of R₁R₂N⁺H₂, Cl⁻. The variable n represents the degree of hydration of the compound X₂MoO₄. It varies as a function of X, for example when X represents Na it is possible to choose n=2, when X represents K is possible to choose n=0. These precursors are commercially available. The pH of the solution is adjusted to a value of less than 5, preferably 4, by means of an aqueous solution of an acid such as HCl. The expected material precipitates. The precipitate is then filtered and washed with water and optionally with ethanol and/or ethyl ether.

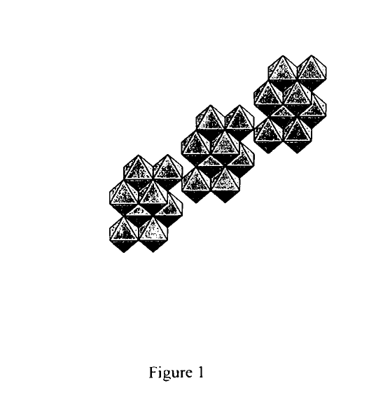

The material of formula (I) consists of infinite 1/∞[Mo₈O₂₇]⁶⁻ chains as illustrated in FIG. 1. These chains are surrounded by X⁺, or H₃O⁺ organic cations and optionally H₂O molecules.

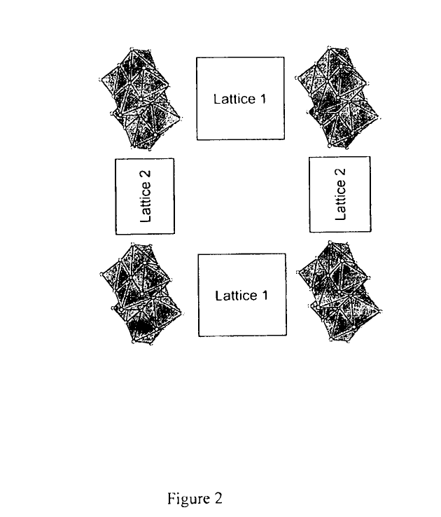

FIG. 1 shows schematically the 1/∞[Mo₈O₂₇]⁶⁻ chain. An octahedron represents an MoO₆ group, the metal center occupying the center of the octahedron. The two sub-lattices occupied by cations around the 1/∞[Mo₈O₂₇]⁶⁻ chain are organized as indicated schematically in FIG. 2. The 1/∞[Mo₈O₂₇]⁶⁻ chains represented therein are parallel to their axis of propagation. The 1/∞[Mo₈O₂₇]⁶⁻ chains are kept parallel by two sub-lattices (the “lattices” 1 and 2 in FIG. 2) in which the cations are distributed. The lattice 1 is occupied by the H₂DABCO²⁺ cations that link the 1/∞[Mo₈O₂₇]⁶⁻ chains via hydrogen bonds. The HDMA⁺, Na⁺ and H₃O⁺ cations are distributed in the lattice 2. The water molecules are not shown in the diagram.

The material of the invention has an optical gap of about 3.1 eV at room temperature.

Under UV radiation (λₑₓ=365 nm for example) or in simple daylight, their color passes from white to violet-purple in the space of a few minutes. This change of color is associated with the coexistence of Mo(VI) and Mo(V) with consequently the existence of d-d optical transitions and possible intervalance transfers resulting in an absorption phenomenon in the visible. Return to the ground state is effected either by moderately heating the material or at room temperature in the dark after a few hours. These materials may give rise to applications in cosmetology, in glazing or lighting, in textiles or inks.

In particular, for applications in cosmetics, the stability of the material and the preservation of its properties where in the presence of water make it possible to envisage it being used in many compositions, and especially in tinted creams, in eye shadows, in blushers, in mascaras, in lipsticks, in foundations, in nail varnishes, in hair dye compositions, such as dyeing creams, coloring lotions and coloring shampoos, and in compositions intended for body tattooing. Neither the water contained in the compositions comprising them nor the water in the epidermis will destabilize the material of the invention.

A person skilled in the art will know how to adapt existing cosmetic formulations in order to introduce compounds of formula (I) thereinto if necessary with the aid of solubilizing agents or compounds enabling them to be put into suspension.

Therefore, another subject of the invention is a cosmetic composition, characterized in that it comprises at least one material of formula (I).

The capacity of the molecules of formula (I) to change color when they are exposed to UV illumination or to daylight makes it possible to vary the shade of the make-up as a function of the exposure to light, which has two advantages: firstly a playful effect, as this is surprising for an observer, but also an esthetic effect, since the intensity of the make-up will be enhanced when the person wearing it is in a highly illuminated environment. The reactivity of the material enables it to adapt rapidly, but not abruptly, to its light environment.

Other applications may be envisioned, in particular the molecules of formula (I) may be used as an indicator of exposure to UV radiation so as to reliably determine the intensity of this exposure, for the purpose of preventing the appearance of pathologies associated with overexposure to UV, such as skin cancers. For this purpose, the materials of formula (I) may be introduced in patches to be applied to the skin. By comparison with a colored specimen it is possible to know when a UV dose, defined in advance has been received by the person using the patch and thus indicate to him that a UV screening cream should be applied or that exposure should be discontinued. For this use, the materials of formula (I) may also be placed in a UV dosimetry kit, for example in a transparent glass or plastic composition, the tint of which varies according to the accumulative UV dose, possibly combined with a maximum-indicating specimen.

Therefore, another subject of the invention is a UV dosimetry article characterized in that it comprises at least one material of formula (I).

Such UV dosimetry articles, patches or kits could be combined with a UV screening cream in the same commercial packaging.

In glazing and spectacles, the material of the invention may be used conventionally to color the glass (whether organic or inorganic) when exposed to UV and thus prevent the user from being dazzled. In particular, this use may be envisioned for spectacles, for automobile windshields or for bottles used for packaging UV-sensitive materials.

Therefore, another subject of the invention is an organic or inorganic glass composition, characterized in that it comprises at least one material of formula (I):

### EXPERIMENTAL PART

### Synthesis of the (H₂DABCO)₂(HDMA)_{0.5}Na_{0.8}(H₃O)_{0.7}[Mo₈O₂₇].3H₂O Material

Na₂MoO₄.2H₂O (3.388 g; 14 mmol) is dissolved in 30 ml of distilled water. After adding DABCO (0.392 g; 3.5 mmol) and DMA.HCl (1.141 g; 14 mmol), the solution is left with stirring for a few minutes and then the pH is adjusted by adding, drop by drop, a 1M hydrochloric acid solution until a pH of 4 is reached, resulting in the appearance of a pale yellow precipitate. The suspension is left with stirring for three hours and then the precipitate is isolated by filtration, washed with water, with ethanol and with ether. The molybdenum yield is around 95%.

1. A material satisfying formula (I):
(H₂DABCO²⁺)₂(R₁R₂NH₂⁺)_{(2-x-y)}(X)ₓ(H₃O⁺)_{y}(Mo₈O₂₇).z(H₂O) (I)
in which:
R₁, R₂, which are identical or different, each represent a C₁-C₁₂ alkyl, C₁-C₁₂ alkenyl or C₁-C₁₂ alkynyl group, which may be linear, branched or cyclic, it being possible for R₁ and R₂ to optionally form together a single alkyl, alkenyl or alkynyl chain so as to form a cyclic structure with the nitrogen atom;
X represents an alcali metal atom;
x is a real number, where 0≦x≦2;
y is a real number, where 0≦y<2;
z is a real number where 0≦z≦10; and
DABCO represents the molecule 1,4-diazabicyclo[2.2.2]octane.

2. The material as claimed in claim 1, wherein R₁=R₂ in formula (I).

3. The material as claimed in claim 1, wherein R₁ and R₂ are chosen from C₁-C₃ alkyls in formula (I).

4. The material as claimed in claim 1, wherein R₁=R₂=CH₃ in formula (I).

5. The material as claimed in claim 1, wherein 0.5≦x≦1 in formula (I).

6. The material as claimed in claim 1, wherein 0.5≦y≦1, in formula (I).

7. The material as claimed in claim 1, wherein X represents an atom chosen from Na and K in formula (I).

8. The material as claimed in claim 1, wherein said material satisfies the formula (Ia):
(H₂DABCO²⁺)₂((CH₃)₂NH₂⁺)_{0.5}(Na)_{0.8}(H₃O⁺)_{0.7}(Mo₈O₂₇).3(H₂O) (Ia).

9. The material as claimed in claim 1, comprising infinite 1/∞[Mo₈O₂₇] chains surrounded by X⁺, or H₃O⁺ organic cations and optionally H₂O molecules.

10. A cosmetic composition, comprising at least one material of formula (I).

11. An organic or inorganic glass composition, comprising at least one material of formula (I).

12. A UV dosimetry article, comprising at least one material of formula (I).

13. The material as claimed in claim 1, wherein x=0.8 in formula (I).

14. The material as claimed in claim 1, wherein y=0.7 in formula (I).

15. The material as claimed in claim 1, wherein x=Na in formula (I).
